(19) United States
(12) Patent Application Publication
(10) Pub. No.: US 2013/0031042 A1
(43) Pub. Date: Jan. 31, 2013

(54) Distributed assured network system (DANS)

(71) Applicants: Sintayehu Dehnie, Bexley, OH (US); Reza Ghanadan, Berkley Heights, NJ (US); Kyle Guan, Wayne, NJ (US)

(72) Inventors: Sintayehu Dehnie, Bexley, OH (US); Reza Ghanadan, Berkley Heights, NJ (US); Kyle Guan, Wayne, NJ (US)

(21) Appl. No.: 13/136,262

(22) Filed: Jul. 27, 2011

(51) Int. Cl. G06N 5/02

(52) U.S. Cl. 706/47; 706/52

(57) ABSTRACT

A computerized method for a distributed assured network system includes a plurality distributed monitoring nodes for sequential feeding the content of respective information sources to a detection agent. The detection agent uses an SPRT-based distributed sequential misbehavior detection scheme to process each MN observation with the probability of a false alarm P̅_{FA} and probability of a miss detection P̅_{MD} until a reliable decision can be made that either there is no malicious or faulty behavior detected, or that malicious or faulty behavior is detected. A cognitive reputation agent is provided within a DBG framework processes the output or detection metric from the detection agent relative to past behavior of the information sources to provide a reputation metric to a trust indication that provides an output representing the trustworthiness of information sources.

### FIELD OF THE INVENTION

The present invention generally relates to tactical information networks, and more particularly to methods and systems for distributed misbehavior detection and mitigation of misbehaving information sources that exhibit faulty and/or malicious behavior.

### BACKGROUND

Next generation tactical systems, Blue Force Tracking (BFT), Warfighter Information Network-Terrestrial (WIN-T), tactical unattended wireless sensors networks, distributed electronic warfare (EW), will rely heavily on information sources such as sensors in providing consistent actionable information. However, information sources in tactical information networks are vulnerable to adversarial compromise and are subject to failure. The presence of faulty and malicious information sources severely limits the attainable performance of tactical networks. Adversarial attack may take various forms: GPS spoofing attack to disrupt operation of tactical networks that rely on the Global Positioning System (GPS) for time synchronization and basic operation of the network; and denial of service (DoS) attack on tactical sensor networks that employ tactical and universal unattended ground sensors (T-UGS and U-UGS), which constrains ISR capabilities of the network. In particular, T-UGS and U-UGS are highly susceptible to adversarial compromise as the sensors have no tamper-resistant capabilities due to their specific characteristics: small size, limited processing power, low memory and low cost; Domain Name Server (DNS) cache poisoning attack where adversary injects malicious DNS record with the intent to cause denial of service (DoS) or direct users to a server under the control of the adversary. Information sources are subject to failure, in particular UGS may exhibit faulty behavior, due to their low-cost and high-volume of production, where they will send erroneous information that will incur substantial performance degradation.

The current art is not robust since the detection technique is characterized by a fixed detection delay and is designed to make decisions based on a single instance of protocol violation. The mitigation techniques, in the current art, are not optimized to work with the detection mechanism, which limits the achievable performance benefits. There is a need in the art for a DANS (Distributed Assured Network System) that requires minimum amount of information, both content and observation time, for convergence in order to provide reliable detection and mitigation of malicious and faulty information sources with optimal latency.

### SUMMARY OF THE INVENTION

The present invention provides a Distributed Assured Network System that includes a plurality of distributed monitoring nodes (MN) for monitoring the content of information sources in tactical information networks, respectively. A detection agent receives the content from the MN, and applies a sequential probability ratio test (SPRT) to the content to provide both a bounded false alarm and miss detection, if any, relative to the content. A reputation agent receives the processing results outputted from the detection agent, and past behavior of the information sources, to process the same through use of a dynamic Bayesian game (DBG) framework to provide a reputation metric.

### BRIEF DESCRIPTION OF THE DRAWINGS

Various embodiments of the present invention are described in detail with reference to the following drawings, in which like items are identified by the same reference designation, wherein:

FIG. 1 is a block diagram showing information processing components for one embodiment of the invention; and

FIG. 2 is a block diagram illustrating a sequential probability ratio test (SPRT) for an embodiment of the invention.

### DETAILED DESCRIPTION OF THE INVENTION

The following definitions of acronyms and terms are used in describing the present invention:

EW—electronic warfare;

GPS—global positioning system;

DoS—denial of service;

T-UGS—tactical unattended ground sensors;

U-UGS—universal ground sensors;

DNS—domain name server;

DANS—distributed assured network systems;

MN—distributed monitoring nodes;

SPRT—sequential probability ratio test;

DBG—dynamic Bayesian game;

FA—false alarm;

MD—miss detection;

λ_{L}—lower threshold based on acceptable P̅_{FA} and P̅_{MD};

λ_{U}—upper threshold;

P̅_{FA}—probability of false alarm;

P̅_{MD}—probability of miss detection MD;

p̅—acceptable level of misbehavior;

Sᵢ—information source;

h(tₖ)—history of the game;

IRS—intelligence surveillance, and reconnaissance;

Detection Metric—measure of presence or absence of misbehavior of information sources;

Reputation Metric—measure of expected future behavior of information sources;

Trustworthiness—quantifiable trust model relative to information sources;

Xₜ—represents MN observation; and

λ_{η}—log likelihood ratio (decision metric) after the n^{th} observation is collected.

The present invention provides a Distributed Assured Network System 1 which applies a set of dynamic and distributed monitoring nodes (MN) 4 to efficiently monitor detect, identify and mitigate adversarial and faulty information sources 3 in tactical information networks. A computer or microprocessor 5 is programmed to perform the present inventive processing. A computer memory 7 is used to store and provide the necessary software.

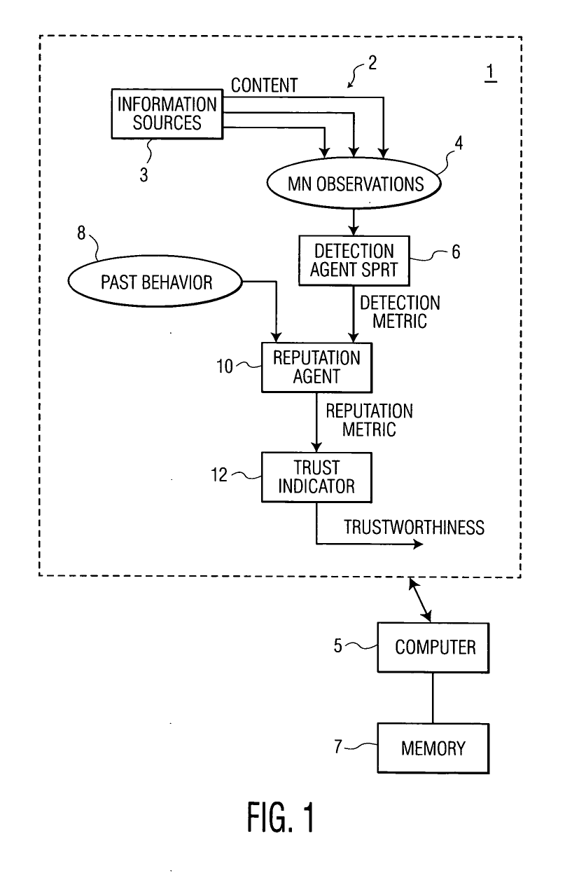

As shown in FIG. 1, DANS is comprised of three components that work together to ensure highly reliable and optimal information processing:

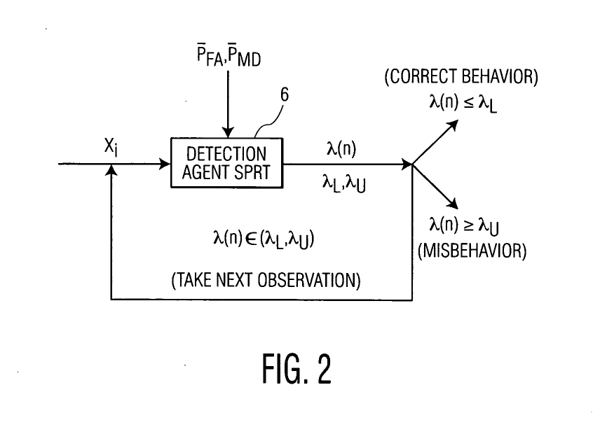

(I) Detection Agent SPRT 6: Distributed MN continuously monitor information sources within transmission range to check for the presence or absence of misbehavior, employing the optimal sequential probability ratio test (SPRT). (See FIG. 2, as described below.) SPRT is an effective technique that provides reliable fast detection with low complexity and a minimum number of observations compared to block detection techniques. It requires a minimum amount of information, which includes both content 2 and observation time (MN observations 4), for convergence in order to provide reliable detection with optimal latency. SPRT ensures both bounded false alarm and miss detection unlike other techniques that provide either a bounded false alarm or miss detection probability, but not both as with the present invention.
(II) Cognitive Reputation Agent 10: This component applies the output of the Detection Agent SPRT 6 to predict expected future behavior of information sources 3 based on their past history (Past Behavior 8). It is formulated within a dynamic Bayesian game (DBG) framework, which has complex structures that fully capture dynamics of the interaction between MN 4 and the control of information sources 3. The DBG model is motivated by the inadequacy of static games which lack the complex structure to fully characterize real world scenarios.
(III). Trust Indicator 12: This component forms and manages a quantifiable trust model based on historical behavioral reputation (past behavior 8) and collaborative filtering received from Reputation Agent 10.

The present SPRT Detection Agent 6 employs SPRT-based distributed sequential misbehavior detection scheme for use in tactical information networks. SPRT is a fast detection technique that yields minimum detection delay for a given error rate. It is optimal in the sense of utilizing a minimum amount of information to make a reliable decision, i.e., SPRT requires minimum content 2 and time to provide reliable detection with optimal latency. Unlike optimal block detection techniques that guarantee either an acceptable false alarm (FA) probability or miss detection (MD) probability, SPRT guarantees both bounded FA and MD probabilities with low complexity and low memory requirement. In a tactical scenario, both FA and MD events incur severe penalty, increasing chances of friendly fire or civilian casualty in case of FA or sustaining heavy losses in the case of MD. MN that are strategically distributed across the network will perform SPRT-based detection. As shown in FIG. 2, the MN sequentially collects information X, from sensors within transmission range until reliable decision is made according to the hypothesis formulated as:
H₀: no malicious or faulty behavior detected
H₁: malicious or faulty behavior detected
   The decision rule to determine behavior of sensors is defined as follows:

$$λ ( n ) \{ \begin{matrix}\leq {λ}_{L} & choose {H}_{0} \\ ∈ ( {λ}_{L} , {λ}_{U} ) & continue monitoring \\ \geq {λ}_{U} & choose {H}_{1}\end{matrix} \qquad ( 1 )$$

where

$$λ ( n ) = {\sum }_{i = 1}^{n} log ( \frac{( P ( {X}_{i} \vert {H}_{1} )}{P ( {X}_{i} \vert {H}_{0} )} )$$

is the log likelihood ratio (decision metric) after the n^{th} observation is collected, λ_{L} and λ_{U} define lower and upper thresholds respectively that are designed based on the acceptable FA (false alarm) and MD (miss detection) probabilities, P̅_{FA} and P̅_{MD}, respectively. Since wireless transmission is subject to error due to channel dynamics, we introduce a design parameter p̅ to characterize acceptable level of misbehavior; p̅ is selected according to required network performance. Next we describe, the Cognitive Reputation Agent 10 that works jointly with the Detection Agent 6 to provide an effective and efficient method to predict expected future behavior of information sources using their past history or behavior 8 as side information.

The Cognitive Reputation Agent 10 is provided within a DBG (dynamic Bayesian game) framework, where the MN 4 and information sources 2 are modeled as utility maximizing rational players. In the ideal scenario, wherein all information sources 2 operate normally, MN 4 and the information sources 2 jointly maximize the net utility of the tactical network. On the other hand, in practical tactical networks, faulty and compromised information sources maximize their own utility while disrupting operation of the tactical information network. We thus formulate the sequential interaction between MN 4 and information sources 2 as a multistage game with incomplete information.

The DBG framework has rich constructs that are best suited to model uncertainty in real-world scenarios. It provides a framework that captures information and temporal structure of the interaction between MN 4 and information sources 2. The information structure of the dynamic game characterizes the level of knowledge MN 4 has about the information sources 2 within transmission range. MN 4 has uncertainty about the behavior of each information source, and this is captured by the incomplete information specification of the game. The temporal structure defines the sequential nature of communication between MN 4 and information sources 2 where the sources transmit first and MN uses the transmission to determine behavior of the source. DBG is played in stages that occur in time periods tₖ, k=0, 1, . . . . Within each stage tₖ, MN and information source Sᵢ interact repeatedly for a period of T seconds during which MN performs an SPRT to determine the behavior of Sᵢ for that duration. The stage game duration T is a trade-off parameter chosen to ensure reliable a decision at a reasonable delay. We denote history of the game, observed by MN, at the end of stage game tₖ by hⱼ(tₖ). We assume that each Sᵢ maintains private information pertaining to its behavior which defines the incomplete information specification of the game where the behavior of Sᵢ not known a priori by the MN The private information of Sᵢ corresponds to the notion of type in Bayesian games. The set of types available to each Sᵢ is defined as Θᵢ={θ₀=regular, θ₁=malicious or faulty}. The type of Sᵢ is denoted by θᵢ which captures the notion that Sᵢ either behaves normally (regular) or deviates from its normal operation due to faulty or malicious behavior, i.e., θᵢε{θ₀, θ₁}. Although the MN has incomplete information about the behavior of each Sᵢ, the Bayesian game construct allows MN to maintain a conditional subjective probability measure, referred to as belief over θᵢ given history of the game h(tₖ). The belief of the MNⱼ about the behavior of Sᵢ at stage game tₖ is defined as μᵢ^{j}(tₖ)=p(θᵢ|hⱼ)). We assume that each MN maintains a strictly positive belief, i.e., μᵢ^{j}(tₖ)>0. Belief is a security parameter that characterizes the trustworthiness of each Sᵢ. Indeed, by maintaining belief the MN deviates from the assumption (as in existing tactical networks) that information sources are always trustworthy. At the beginning of each stage game, the MN enters the game with a prior belief obtained from a previous stage of the game. Bayes' rule is used to update the belief at the end of each stage game combining output of SPRT and past behavior of Sᵢ.

$${μ}_{i}^{j} ( {t}_{k} ) = \frac{p ( {h}_{j} ( {t}_{k} ) \vert {θ}_{i} ) {μ}_{i}^{j} ( {t}_{k - 1} )}{{\sum }_{{\tilde{θ}}_{i} ∈ {Θ}_{i}} p ( {h}_{j} ( {t}_{k} ) \vert {\tilde{θ}}_{i} ) {\tilde{μ}}_{i}^{j} ( {t}_{k - 1} )} \qquad ( 2 )$$

where p(hⱼ(tₖ)|θᵢ) is the output of the SPRT based on the current observation and type of Sᵢ, i.e., p(hⱼ(tₖ)|θᵢ=θ₀)=1− P̅_{FA} probability of detecting normal behavior, and p(hⱼ(tₖ)|θᵢ=θ₁)=1− P̅_{MD} probability of detecting misbehavior, whereby μᵢ^{j}(tₖ₋₁) is the belief at the end of the previous stage of the game, and it provides a measure of past behavior. Note that the updated belief provides a measure of trustworthiness.

The equilibrium concept of DBG is belief-based which will enable the MN to weigh the contribution of each Sᵢ based on its trustworthiness. Indeed, the proposed DBG framework satisfies the requirements for the existence of Perfect Bayesian Nash equilibrium (PBE), where one of the requirements is known as sequential rationality. Sequential rationality states that given its updated belief a rational MN must choose an optimal strategy from the current stage of the game onwards. Sequential rationality enables the MN to filter information based on trustworthiness of sources to ensure reliable information processing. Thus, the DBG based reputation mechanism yields a reliability measure that takes into account past history. The reliability measure is efficient in the sense that it is obtained using Bayesian reasoning taking into account all observations.

The Advantages of Distributed Assured Network System (DANS) will now be summarized. The present invention provides measurable metrics such as net utility gain, reliability gain and economic gain (in terms of cost-utility ratio) that measure achievable performance improvement, resilience and effectiveness of the System. The invention guarantees significantly high net utility with low cost-utility ratio. Some of the tactical networks to which DANS can be applied are as follows:
ISR (Intelligence, Surveillance, and Reconnaissance) networks to ensure reliable ISR and situational awareness;
unattended tactical sensor networks to ensure reliable information processing;
cognitive networks to provide reliable operation;
data networks to mitigate denial of service attacks; and
reliable Electronic Attack and Support operation in next generation EW (Electronic Warfare) systems.

The foregoing description makes use of tactical information network as an example only and not as a limitation. It is important to point out that the methods illustrated in the body of this invention can apply to any network system. The invention is applicable to other systems of wireless communication and also other mobile and fixed wireless sensor network systems. Other variations and modifications consistent with the invention will be recognized by those of ordinary skill in the art.

What we claim is:

1. A method for a distributed assured network system, comprising the steps of:
distributing monitoring nodes (MN) to sequentially monitor and collect information sources to be checked for the presence or absence of misbehavior, the MN providing MN observations from the content of the monitored information sources;
providing a detection agent to employ an optimal sequential probability ratio test (SPRT) to process the MN observations to ensure both bounded false alarm and miss detection outputs relative to the content of the information source;
providing a reputation agent to process the output from said detection agent to predict the expected future behavior of said information sources based upon the known past behavior thereof; and
providing a trust indicator responsive to an output from said reputation agent to form and manage a quantifiable trust model based upon historical behavioral expectation and collaborative filtering received from said reputation agent, the trust model being indicative of the trustworthiness of the information sources.

2. The method of claim 1, wherein the information sources are unattended wireless sensors within transmission range of said MN.

3. The method of claim 1, wherein the detection agent SPRT processing steps include:
receiving the MN collected information;
receiving both the P̅_{F}, (probability of a false alarm), and the P̅_{MD} (probability of a miss detection), for each MN observation;
computing from both the P̅_{FA} and the P̅_{MD} applied against the MN observations, both the lower threshold λ_{L} and the upper threshold λ_{U} based on acceptable P̅_{FA} and P̅_{MD};
computing for each MN observation the log likelihood ratio λ_{η} to determine the behavior of the monitored information sources defined as follows:
$$λ ( n ) \{ \begin{matrix}\leq {λ}_{L} & choose {H}_{0} \\ ∈ ( {λ}_{L} , {λ}_{U} ) & continue monitoring \\ \geq {λ}_{U} & choose {H}_{1}\end{matrix} \\ where \\ λ ( n ) = {\sum }_{i = 1}^{n} log ( \frac{( P ( {X}_{i} \vert {H}_{1} )}{P ( {X}_{i} \vert {H}_{0} )} )$$
where Xᵢ represents an MN observation, H₀ represents no malicious or faulty behavior detected, and H₁ represents malicious or faulty behavior detected.

4. The method of claim 1, further including the steps of:
designing said reputation agent within a Dynamic Bayesian Game (DBG) framework;
modeling said MN and information sources as utility maximizing players within said DBG framework;
formulating sequential interaction between said MN and information source as a multistage game with incomplete information, whereby the DBG framework captures information and temporal structure of interaction between said MN and information sources.

5. The method of claim 4, wherein said temporal structure defines the sequential nature of communication between said information sources and said MN, including the steps of:
said MN just receiving information transmitted by said information sources; and
said MN using the received information for determining the behavior of each information source.

6. The method of claim 5, further including the steps of:
playing said DBG in stages that occur in time periods tₖ, where k+0, 1, 2 . . . ; and
repeatedly interacting said MN and information sources Sᵢ for a period of T seconds during which MN performs an SPRT, for determining the behavior of Sᵢ over the period.

7. The method of claim 6, further including the steps of:
assuming that each Sᵢ maintains private information pertaining to its behavior not initially known by said MN;
corresponding the private information of each Sᵢ to the notion of type in Bayesian games;
defining the set of types available to Sᵢ, as Θᵢ={θ₀=regular, θ₁=malicious or faulty};
denoting the type of Sᵢ by θᵢ to capture the notion that Sᵢ either behaves normally (regularly) or deviates from its normal operation due to faulty or malicious behavior, whereby θᵢε{θ₀, θ₁};
using Bayesian game construct to maintain “belief,” a conditional subjective probability measure, over θᵢ given history of the game h(tₖ); and
defining as μᵢ^{j}(tₖ)=p(θᵢ|hⱼ(tₖ)) the belief of an MNⱼ about the behavior of Sᵢ at stage game tₖ, whereby it is assumed each MN maintains only a positive belief defined as μᵢ^{j}(tₖ)>0, with belief being a security parameter characterizing the trustworthiness of each Sᵢ.

8. The method of claim 7, further including the steps of:
entering MN with a prior belief obtained from a previous stage of the game; and
using Bayes' rule to update the belief at the end of each stage game by combining the output of SPRT and the past behavior of Sᵢ.

9. The method of claim 8, wherein the step of using Bayes' rule includes the following computational steps:
$${μ}_{i}^{j} ( {t}_{k} ) = \frac{p ( {h}_{j} ( {t}_{k} ) \vert {θ}_{i} ) {μ}_{i}^{j} ( {t}_{k - 1} )}{{\sum }_{{\tilde{θ}}_{i} ∈ {Θ}_{i}} p ( {h}_{j} ( {t}_{k} ) \vert {\tilde{θ}}_{i} ) {\tilde{μ}}_{i}^{j} ( {t}_{k - 1} )}$$
where p(hⱼ(tₖ)|θᵢ) is the output of the SPRT based on the current observation and type of Sᵢ, i.e., p(hⱼ(tₖ)|θᵢ=θ₀)=1− P̅_{FA} (probability of detecting normal behavior), and p(hⱼ(tₖ)|θᵢ=θ₁)=1− P̅_{MD} (probability of detecting misbehavior), whereby μᵢ^{j}(tₖ₋₁) is the belief at the end of the previous stage of the game, and it provides a measure of past behavior.

10. A method for an assured network system comprising the steps of:
distributing monitoring nodes (MN) to sequentially monitor and collect information sources to be checked for the presence or absence of misbehavior, the MN providing MN observations from the content of the monitored information sources;
providing a detection agent to employ an optimal sequential probability ratio test (SPRT) to process the MN observations to ensure both bounded false alarm and miss detection outputs relative to the content of the information source;
providing a reputation agent to process the output from said detection agent to predict the expected future behavior of said information sources based upon the known past behavior thereof; and
providing a trust indicator responsive to an output from said reputation agent to form and manage a quantifiable trust model based upon historical behavioral expectation and collaborative filtering received from said reputation agent, the trust model being indicative of the trustworthiness of the information sources;
wherein said information sources are unattended wireless sensors within transmission range of MN; and
said detection agent SPRT processing steps include:
receiving the MN collected information;
receiving both the P̅_{FA} (probability of a false alarm), and the P̅_{MD} (probability of a miss detection), for each MN observation;
computing from both the P̅_{FA} and the P̅_{MD} applied against the MN observations, both the lower threshold λ_{L} and the upper threshold λ_{U} based on acceptable P̅_{FA} and P̅_{MD};
computing for each MN observation the log likelihood ratio λ_{η} to determine the behavior of the monitored information sources defined as follows:
$$λ ( n ) \{ \begin{matrix}\leq {λ}_{L} & choose {H}_{0} \\ ∈ ( {λ}_{L} , {λ}_{U} ) & continue monitoring \\ \geq {λ}_{U} & choose {H}_{1}\end{matrix} \\ where \\ λ ( n ) = {\sum }_{i = 1}^{n} log ( \frac{( P ( {X}_{i} \vert {H}_{1} )}{P ( {X}_{i} \vert {H}_{0} )} )$$
where Xᵢ represents an MN observation, H₀ represents no malicious or faulty behavior detected, and H₁ represents malicious or faulty behavior detected.

11. The method of claim 10, further including the steps of:
designing said reputation agent within a Dynamic Bayesian Game (DBG) framework;
modeling said MN and information sources as utility maximizing players within said DBG framework;
formulating sequential interaction between said MN and information source as a multistage game with incomplete information, whereby the DBG framework captures information and temporal structure of interaction between said MN and information sources.

12. The method of claim 11, wherein said temporal structure defines the sequential nature of communication between said information sources and said MN, including the steps of:
said MN just receiving information transmitted by said information sources; and
said MN using the received information for determining the behavior of each information source.

13. The method of claim 12, further including the steps of:
playing said DBG in stages that occur in time periods tₖ, where k+0, 1, 2 . . . ; and
repeatedly interacting said MAT and information sources Sᵢ for a period of T seconds during which MN performs an SPRT, for determining the behavior of Sᵢ over the period.

14. The method of claim 13, further including the steps of:
assuming that each Sᵢ maintains private information pertaining to its behavior not initially known by said MN;
corresponding the private information of each Sᵢ to the notion of type in Bayesian games;
defining the set of types available to Sᵢ, as Θᵢ={θ₀=regular, θ₁=malicious or faulty};
denoting the type of Sᵢ by θᵢ to capture notion that Sᵢ either behaves normally (regularly) or deviates from its normal operation due to faulty or malicious behavior, whereby θᵢε{θ₀, θ₁};
using Bayesian game construct to maintain “belief,” a conditional subjective probability measure, over θᵢ given history of the game h(tₖ); and
defining as μₜ^{j}(tₖ)=p(θᵢ|hⱼ(tₖ)) the belief of an MNⱼ about the behavior of Sᵢ at stage game tₖ, whereby it is assumed each MN maintains only a positive belief defined as μᵢ^{j}(tₖ)>0, with belief being a security parameter characterizing the trustworthiness of each Sᵢ.

15. The method of claim 14, further including the steps of:
entering MN with a prior belief obtained from a previous stage of the game; and
using Bayes' rule to update the belief at the end of each stage game by combining the output of SPRT and the past behavior of Sᵢ.

16. The method of claim 15, wherein the step of using Bayes' rule includes the following computational steps:
$${μ}_{i}^{j} ( {t}_{k} ) = \frac{p ( {h}_{j} ( {t}_{k} ) \vert {θ}_{i} ) {μ}_{i}^{j} ( {t}_{k - 1} )}{{\sum }_{{\tilde{θ}}_{i} ∈ {Θ}_{i}} p ( {h}_{j} ( {t}_{k} ) \vert {\tilde{θ}}_{i} ) {\tilde{μ}}_{i}^{j} ( {t}_{k - 1} )}$$
where p(hⱼ(tₖ)|θᵢ) is the output of the SPRT based on the current observation and type of Sᵢ, i.e., p(hⱼ(tₖ)|θᵢ=θ₀)=1− P̅_{FA} (probability of detecting normal behavior), and p(hⱼ(tₖ)|θᵢ=θ₁)=1− P̅_{MD} (probability of detecting misbehavior), whereby μᵢ^{j}(tₖ₋₁) is the belief at the end of the previous stage of the game, and it provides a measure of past behavior.

17. A method for an assured network system comprising the steps of:
distributing monitoring nodes (MN) to sequentially monitor and collect information sources to be checked for the presence or absence of misbehavior, the MN providing MN observations from the content of the monitored information sources;
providing a detection agent to employ an optimal sequential probability ratio test (SPRT) to process the MN observations to ensure both bounded false alarm and miss detection outputs relative to the content of the information source;
providing a reputation agent to process the output from said detection agent to predict the expected future behavior of said information sources based upon the known past behavior thereof; and
providing a trust indicator responsive to an output from said reputation agent to form and manage a quantifiable trust model based upon historical behavioral expectation and collaborative filtering received from said reputation agent, the trust model being indicative of the trustworthiness of the information sources;
wherein said information sources are unattended wireless sensors within transmission range of MN; and
said detection agent SPRT processing steps include:
receiving the MN collected information;
receiving both the P̅_{FA} (probability of a false alarm), and the P̅_{MD} (probability of a miss detection), for each MN observation;
computing from both the P̅_{FA} and the P̅_{MD} applied against the MN observations, both the lower threshold λ_{L} and the upper threshold μ_{U} based on acceptable P̅_{FA} and P̅_{MD};
computing for each MN observation the log likelihood ratio λ_{η} to determine the behavior of the monitored information sources defined as follows:
$$λ ( n ) \{ \begin{matrix}\leq {λ}_{L} & choose {H}_{0} \\ ∈ ( {λ}_{L} , {λ}_{U} ) & continue monitoring \\ \geq {λ}_{U} & choose {H}_{1}\end{matrix} \\ where \\ λ ( n ) = {\sum }_{i = 1}^{n} log ( \frac{( P ( {X}_{i} \vert {H}_{1} )}{P ( {X}_{i} \vert {H}_{0} )} )$$
where Xᵢ represents an MN observation, H₀ represents no malicious or faulty behavior detected, and H₁ represents malicious or faulty behavior detected;
designing said reputation agent within a Dynamic Bayesian Game (DBG) framework;
modeling said MN and information sources as utility maximizing players within said DBG framework;
formulating sequential interaction between said MN and information source as a multistage game with incomplete information, whereby the DBG framework captures information and temporal structure of interaction between said MN and information sources;
wherein said temporal structure defines the sequential nature of communication between said information sources and said MN, including the steps of:
said MN just receiving information transmitted by said information sources; and
said MN using the received information for determining the behavior of each information source;
playing said DBG in stages that occur in time periods tₖ, where k+0, 1, 2 . . . ; and
repeatedly interacting said MN and information sources Sᵢ for a period of T seconds during which MN performs an SPRT, for determining the behavior of Sᵢ over the period;
assuming that each Sᵢ maintains private information pertaining to its behavior not initially known by said MN;
corresponding the private information of each Sᵢ to the notion of type in Bayesian games;
defining the set of types available to Sᵢ, as Θᵢ={θ₀=regular, θ₁=malicious or faulty};
denoting the type of Sᵢ by θᵢ to capture the notion that Sᵢ either behaves normally (regularly) or deviates from its normal operation due to faulty or malicious behavior, whereby θᵢε{θ₀, θ₁};
using Bayesian game construct to maintain “belief,” a conditional subjective probability measure, over θᵢ given history of the game h(tₖ); and
defining as μᵢ^{j}(tₖ)=p(θᵢ|hⱼ(tₖ)) the belief of an MNⱼ about the behavior of Sᵢ at stage game tₖ, whereby it is assumed each MN maintains only a positive belief defined as μᵢ^{j}(tₖ)>0, with belief being a security parameter characterizing the trustworthiness of each Sᵢ;
entering MN with a prior belief obtained from a previous stage of the game; and
using Bayes' rule to update the belief at the end of each stage game by combining the output of SPRT and the past behavior of Sᵢ;
wherein the step of using Bayes' rule includes the following computational steps:
$${μ}_{i}^{j} ( {t}_{k} ) = \frac{p ( {h}_{j} ( {t}_{k} ) \vert {θ}_{i} ) {μ}_{i}^{j} ( {t}_{k - 1} )}{{\sum }_{{\tilde{θ}}_{i} ∈ {Θ}_{i}} p ( {h}_{j} ( {t}_{k} ) \vert {\tilde{θ}}_{i} ) {\tilde{μ}}_{i}^{j} ( {t}_{k - 1} )}$$
where p(hⱼ(tₖ)|θᵢ) is the output of the SPRT based on the current observation and type of Sᵢ, i.e., p(hⱼ(tₖ)|θᵢ=θ₀)=1− P̅_{FA} (probability of detecting normal behavior), and p(hⱼ(tₖ)|θᵢ=θ₁)=1− P̅_{MD} (probability of detecting misbehavior), whereby μᵢ^{j}(tₖ₋₁) is the belief at the end of the previous stage of the game, and it provides a measure of past behavior.
